(19) United States
(12) Patent Application Publication
(10) Pub. No.: US 2009/0167791 A1
(43) Pub. Date: Jul. 2, 2009

(54) Image Display Method, Image Display Device, Image Display Monitor, and Television Receiver

(76) Inventor: Makoto Shiomi, Tenri-shi Nara (JP)

Correspondence Address: HARNESS, DICKEY & PIERCE, P.L.C., P.O. BOX 8910, RESTON, VA, 20195, US

(21) Appl. No.: 12/085,461

(22) PCT Filed: Sep. 6, 2006
(86) PCT No.: PCT/JP2006/317619

§ 371 Date: May 23, 2008

(30) Foreign Application Priority Data
Nov. 25, 2005 (JP) 2005-341146

(51) Int. Cl. G09G 5/10; G09G 3/34; H04N 5/44

(52) U.S. Cl. 345/691; 345/84; 348/725; 348/E05.096

(57) ABSTRACT

In one embodiment of the present invention, when an image is displayed in an image display device which has a frequency of 50 to 70 Hz in one frame period, a control LSI is set so that, in the case where the frame average luminance of a pixel is in the range of 150 [cd/m²] to 350 [cd/m²], the contrast ratio between subframe periods is set to: a range of not greater than 50 and not smaller than 1.5 when the luminance is 150 [cd/m²]; a range of not greater than 3.5 and not smaller than 1.5 when the luminance is 200 [cd/m²]; a range of not greater than 2.2 and not smaller than 1.5 when the luminance is 250 [cd/m²]; a range of not greater than 1.8 and not smaller than 1.5 when the luminance is 300 [cd/m²]; 1.5 when the luminance is 350 [cd/m²], and, for a frame average luminance other than the frame average luminance in the range, the contrast ratio is set so as to be monotonously changed between the contrast ratios corresponding to the respective frame average luminance. As a result, flicker visibility can be prevented and moving image blur can be suppressed, thereby realizing an image display device that can display a moving image with high quality.

### TECHNICAL FIELD

The present invention relates to image display devices that use a hold-type display element such as a liquid crystal display element or an EL (Electro Luminescence) display element.

### BACKGROUND ART

In recent years, a variety of display devices have been developed and commercialized, e.g. liquid crystal display devices, plasma display devices, and organic EL display devices, let alone CRT (Cathode-Ray Tube) display devices.

In a display device, such as a CRT display device, that performs an impulse-type display (a display performed only during a light-emitting period), a pixel in its non-selection period provides a black display. On the other hand, in a hold-type display device (a display in which an image of a previous frame is retained until new image data is written) such as a liquid crystal display device or an organic EL display device, a pixel in its non-selection period retains a display content last written (this is a normal display in a hold-type display device).

In a normal display made by such a hold-type display device, there arises a problem with moving image blur when a moving image is displayed. Such a problem arises from the fact that a pixel retains a display content even in its non-selection period according to a hold-type display device. This problem will not be solved even if a response speed of the pixel is improved.

Some conventional hold-type display devices perform a time-division driving in order to prevent moving image blur. The time-division driving is a driving method in which one vertical period (i.e. one frame) is divided into a plurality of subframes so that a signal is written, more than once, into one pixel.

More specifically, even in the case of a hold-type display device, if a low-luminance display (i.e. a display similar to a black display) is performed in at least one of the subframes with the use of the time-division driving, then it is possible to perform such a pseudo display that is similar to an impulse-type display. This contributes to prevent the moving image blur.

For example, Patent Document 1 (Japanese Unexamined Patent Application Publication No. 2001-296841 (Tokukai 2001-296841; published on Oct. 26, 2001)) is known as disclosing a time-division driving for use in a liquid crystal display device.

Further, Patent Document 2 (Japanese Unexamined Patent Application Publication No. 2001-184034 (Tokukai 2001-184034; published on Jul. 6, 2001)) discloses a liquid crystal display device in which twice activation is carried out during one frame for displaying one image on the screen so that the impulse driving is performed. In addition, Patent Document 3 (Japanese Unexamined Patent Application Publication No. 2003-262846 (Tokukai 2003-262846; published on Sep. 19, 2003)) also discloses a display device that employs an impulse-type display method.

This, however, causes the following problem. Namely, if a display device that uses a hold-type display element carries out the above pseudo impulse driving so that moving-image performance is improved, then flicker readily occurs for such reasons that display devices have recently had higher luminance and a large-sized screen. The flicker is significantly perceptible particularly in such a case that a frame frequency is low, or display luminance is high. Such a flicker tires a user's eyes.

The present invention was accomplished in view of the above problems. An object of the present invention is to embody such an image display device that flicker visibility can be prevented and moving image blur can be suppressed, whereby a high-quality moving image can be displayed.

### DISCLOSURE OF INVENTION

According to an image display method of the present invention, in order to solve the above problems, an image is displayed by dividing one frame period into a plurality of subframe periods. The frequency of the one frame period falls in the range of 50 to 70 Hz. The method includes a time-division driving. According to the driving, in the range of 150 [cd/m²](nit) to 350 [cd/m²] of frame average luminance of a pixel which range is specified by an input signal: (i) luminance of a first subframe period which is at least one of the subframe periods is set so as to be greater than the frame average luminance; and (ii) luminance of a second subframe period which is at least other one of the subframe periods is set so as to be smaller than the frame average luminance. The contrast ratio between the first and second subframe periods in the time-division driving is set to: a range of not greater than 50 and not smaller than 1.5 when the frame average luminance is 150 [cd/m²]; a range of not greater than 3.5 and not smaller than 1.5 when the frame average luminance is 200 [cd/m²]; a range of not greater than 2.2 and not smaller than 1.5 when the frame average luminance is 250 [cd/m²]; a range of not greater than 1.8 and not smaller than 1.5 when the frame average luminance is 300 [cd/m²]; and 1.5 when the frame average luminance is 350 [cd/m²]. For a frame average luminance other than the frame average luminance in the range, the contrast ratio is set so as to be monotonously changed between the contrast ratios corresponding to the respective display luminance.

Further, according to an image display device of the present invention, in order to solve the above problems, such driving means is provided that an image is displayed by dividing one frame period into a plurality of subframe periods. The frequency of the one frame period falls in the range of 50 to 70 Hz. The method includes a time-division driving. The driving means controls the plurality of subframe periods so that, in the range of 150 [cd/m²] to 350 [cd/m²] of frame average luminance of a pixel which range is specified by an input signal: (i) luminance of a first subframe period which is at least one of the subframe periods is set so as to be greater than the frame average luminance; and (ii) luminance of a second subframe period which is at least other one of the subframe periods is set so as to be smaller than the frame average luminance. The driving means sets the contrast ratio between the first and second subframe periods in the range to: a range of not greater than 50 and not smaller than 1.5 when the frame average luminance is 150 [cd/m²]; a range of not greater than 3.5 and not smaller than 1.5 when the frame average luminance is 200 [cd/m²]; a range of not greater than 2.2 and not smaller than 1.5 when the frame average luminance is 250 [cd/m²]; a range of not greater than 1.8 and not smaller than 1.5 when the frame average luminance is 300 [cd/m²]; and 1.5 when the frame average luminance is 350 [cd/m²]. For a frame average luminance other than the frame average luminance in the range, the contrast ratio is set so as to be monotonously changed between the contrast ratios corresponding to the respective display luminance.

According to the above arrangement, when an image is displayed in the image display device having a frequency of 50 to 70 Hz in the one frame period, luminances of the first and second subframe periods are set as different from each other in the range. The contrast ratio between the first and second subframe periods in the range is set as above. As a result, a luminance difference can be provided between the first and second subframes so that flicker visibility is prevented. Consequently, a flicker can be prevented, and moving image blur can be suppressed, whereby a high-quality moving image can be displayed.

Further, according to the image display method of the present invention, the luminance difference between the first and second subframe periods in the time-division driving falls within the range of 100 to 200 [cd/m²], at least in the range of 100 to 350 [cd/m²] of the accumulated luminance.

Still further, according to the image display device of the present invention, in addition to the above arrangement, the driving means sets a luminance difference between the first and second subframe periods to the range of 100 to 200 [cd/m²], at least in the range of 100 to 350 [cd/m²] of the accumulated luminance.

According to the aforementioned arrangement, particularly in such a situation that such an image is viewed that contains a lot of different luminance values, e.g. for use in television, a rough image and noise can be prevented.

According to an image display method of the present invention, in order to solve the above problems, an image is displayed by dividing one frame period into a plurality of subframe periods. The frequency of the one frame period falls in the range of 50 to 70 Hz. The method includes a time-division driving. According to the driving, in the range of 150 [cd/m²] to 350 [cd/m²] of frame average luminance of a pixel which range is specified by the input signal: (i) luminance of a first subframe period which is at least one of the subframe periods is set so as to be greater than the frame average luminance; and (ii) luminance of a second subframe period which is at least other one of the subframe periods is set so as to be smaller than the frame average luminance. The contrast ratio between the first and second subframe periods in the time-division driving is set to not smaller than 1.5. The luminance difference between the first and second subframe periods in the time-division driving is set to: a range of not greater than 300 [cd/m²] when the frame average luminance is 150 [cd/m²]; a range of not greater than 230 [cd/m²] when the frame average luminance is 200 [cd/m²]; a range of not greater than 190 [cd/m²] when the frame average luminance is 250 [cd/m²]; a range of not greater than 160 [cd/m²] when the frame average luminance is 300 [cd/m²]; and 150 [cd/m²] when the frame average luminance is 350 [cd/m²]. For a frame average luminance other than the frame average luminance in the range, the luminance difference is set so as to be monotonously changed between the contrast ratios corresponding to the respective display luminance.

Furthermore, according to an image display device of the present invention, in order to solve the above problems, such driving means is provided that an image is displayed by dividing one frame period into a plurality of subframe periods. The frequency of the one frame period falls in the range of 50 to 70 Hz. The driving means controls the plurality of subframe periods so that, in the range of 150 [cd/m²] to 350 [cd/m²] of frame average luminance of a pixel which range is specified by the input signal: (i) luminance of a first subframe period which is at least one of the subframe periods is set so as to be greater than the frame average luminance; and (ii) luminance of a second subframe period which is at least other one of the subframe periods is set so as to be smaller than the frame average luminance. The driving means sets the contrast ratio between the first and second subframe periods in the range to not smaller than 1.5. The luminance difference between the first and second subframe periods in the range is set to: a range of not greater than 300 [cd/m²] when the frame average luminance is 150 [cd/m²]; a range of not greater than 230 [cd/m²] when the frame average luminance is 200 [cd/m²]; a range of not greater than 190 [cd/m²] when the frame average luminance is 250 [cd/m²]; a range of not greater than 160 [cd/m²] when the frame average luminance is 300 [cd/m²]; and 150 [cd/m²] when the frame average luminance is 350 [cd/m²]. For a frame average luminance other than the frame average luminance in the range, the luminance difference is set so as to be monotonously changed between the contrast ratios corresponding to the respective display luminance.

According to the aforementioned arrangement, when an image is displayed in the image display device having a frequency of 50 to 70 Hz in the one frame period, luminance values of the first and second subframe periods are set as different from each other in the range. The contrast ratio and the luminance difference between the first and second subframe periods in the range are set as above. As a result, a luminance difference can be provided between the first and second subframes so that a flicker is not perceptible. Consequently, a flicker can be prevented, and moving image blur can be suppressed, whereby a high-quality moving image can be displayed.

Further, according to the image display method of the present invention, a maximum value of luminance in each of the subframe periods in the time-division driving is indicated by a product of frame average luminance and n where n indicates the number of the subframes.

Yet further, according to the image display device of the present invention, in addition to the aforementioned arrangement, the driving means determines a maximum value of luminance in each of the subframe periods as indicated by a product of frame average luminance and n where n indicates the number of the subframes.

As a result, it is possible to limit the number of subframes so that the contrast ratio and the luminance difference are within the aforementioned ranges. Such a number of subframes is specifically not greater than 3.

Furthermore, an image display monitor of the present invention includes any one of the aforementioned image display devices, and a signal input section that transmits an externally input image signal to the image display device. Also, a television receiver of the present invention includes a receiving apparatus that receives television broadcast, and any one of the aforementioned image display devices. The image display device displays an image of television broadcast received by the receiving apparatus. As described above, the image display device can display a high-quality moving image, and therefore is preferably applicable to an image display monitor and a television receiver.

The image display device may be embodied by means of hardware or a program executed by a computer. Specifically, the program according to the present invention operates a computer, acting as driving means of the image display device. Such a program is pre-recorded in a recording medium according to the present invention.

For example, if the recording medium is read out by a computer, and such programs are executed by the computer, the computer operates as the image display device. As a result, a high-quality moving image can be displayed in a manner similar to the aforementioned image display device.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a block diagram showing a main arrangement of a control LSI provided in an image display device, and FIG. 1 shows an embodiment of the present invention.

FIG. 2 is a block diagram showing a main arrangement of the image display device.

FIG. 3 is a diagram illustrating an operation of the image display device.

FIG. 4 is a graph illustrating a relationship between a flicker visible limit and a driving frequency.

FIG. 5 is a graph illustrating a relationship between luminance and a flicker-detection limit contrast in the case where a refresh rate is 60 (Hz).

FIG. 6 is a graph illustrating characteristics of display luminance and luminance differences, respectively in an image display device of the present embodiment and in a comparative example.

FIG. 7 is a graph illustrating characteristics of display luminance and a contract ratio, respectively in an image display device according to the present embodiment and in a comparative example.

### DESCRIPTION OF THE CODES

1 image display device
11a display element (pixel)
30 control LSI (driving means)

### BEST MODE FOR CARRYING OUT THE INVENTION

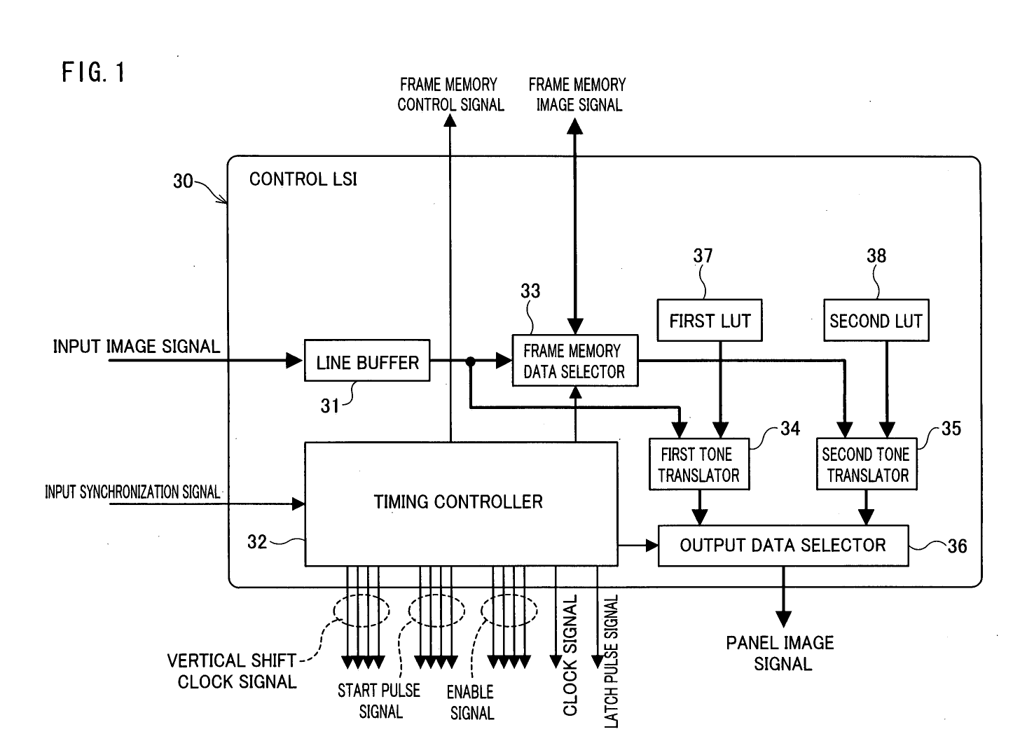

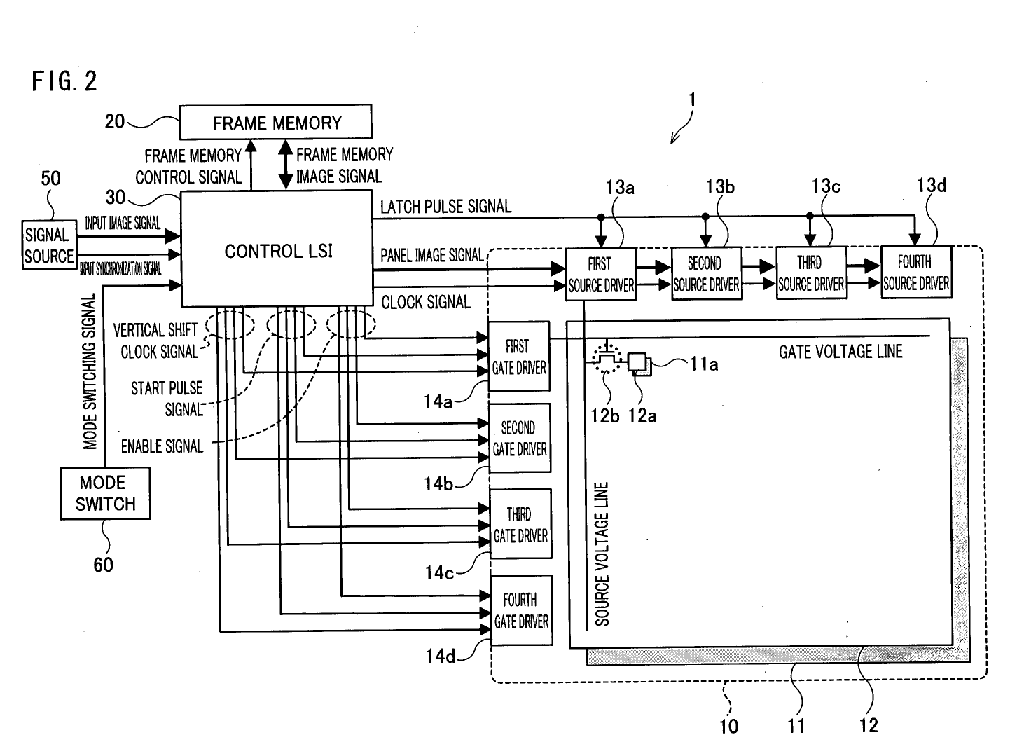

One embodiment of the present invention is described below with reference to FIG. 1 through FIG. 7. Explained first with reference to FIG. 2 is a schematic arrangement of an image display device according to the present embodiment. In FIG. 2, an image display device 1 includes a display panel 10, a frame memory 20 and a control LSI 30. In the image display device 1, an image can be displayed, in accordance with an input image signal, on the display panel 10. In the case where a device including the image display device 1 is an image display monitor, for example, a signal source 50 serves as a signal input section that transmits an externally input image signal to the image display device 1. In the case where a device including the image display device 1 is a TV (television) receiver, a receiving apparatus that receives television broadcast is used as the signal source 50, and the image display device 1 displays an image in accordance with the television broadcast received by the receiving apparatus.

A mode switch 60 outputs a mode-switching signal to the control LSI 30 in response to a user's operation so that the display modes can be switched in accordance with the user's instruction. More specifically, when the mode switch 60 is operated in order for the user to switch the display modes, a mode-switching signal is supplied from the mode switch 60 to the control LSI 30, and switching control of the display modes is then performed in the control LSI 30.

The display panel 10 constitutes image display means, including: a display element array 11; a TFT substrate 12; source drivers 13a to 13d; and gate drivers 14a to 14d. According to the present embodiment, the display element array 11 has a plurality of display elements 11a, (pixel section) made of liquid crystal material, which are disposed in a matrix. Instead of the liquid crystal material, an organic EL member may be used.

Disposed in a matrix in a display region of the TFT substrate 12 are: a pixel electrode 12a that drives the display element 11a; and a TFT 12b that, serving as a switching element, switches on and off a charge supply (i.e. a display voltage) to the pixel electrode 12a. The pixel electrode 12a and the TFT 12b are provided for a respective one of the display elements 11a. A source driver and a gate driver are disposed on the periphery of the display region of the display element array 11 and the TFT substrate 12. The source driver and the gate driver carry out display drive with respect to the pixel electrode 12a and the display element 11a via a respective one of the TFTs 12b. As for the source drivers, first through fourth source drivers 13a to 13d that are cascade-connected are illustrated as an example, and, as for the gate drivers, first through fourth gate drivers 14a to 14d that are cascade-connected are illustrated as an example.

Provided in the display region of the TFT substrate 12 are: a plurality of source voltage lines that are connected to the source drivers and provided with a source voltage (i.e. a display voltage); and a plurality of gate voltage lines that are connected to the gate drivers and provided with a gate voltage (i.e. a scanning signal voltage). The plurality of source voltage lines and the plurality of gate voltage lines are intersected with each other. The pixel electrode 12a and the TFT 12b are provided in the vicinity of each intersecting parts of the lines.

The gate electrode of a TFT 12b is connected to a respective one of the gate voltage lines (a gate voltage line in an intersecting part of the TFT 12b). The source electrode of the TFT 12b is connected to a respective one of the source voltage lines (a source voltage line in the intersecting part of the TFT 12b). The drain electrode of the TFT 12b is connected to the pixel electrode 12a.

The frame memory 20 stores an image signal corresponding to one frame, which image signal is displayed on the display panel 10. The control LSI 30 is display control means for controlling each of the sections. The arrangement of the control LSI 30 will be later described in detail.

The following description deals with a basic image-displaying method in an image display device 1 having the aforementioned arrangement.

First, the control LSI 30 sequentially transmits a panel image signal to the first source driver 13a in synchronization with a clock signal. The panel image signal is to be displayed on each of the pixel sections of one horizontal line. The first through fourth source drivers 13a through 13d are, as illustrated in FIG. 2, cascade-connected. Therefore, in response to a plurality of clock signal pulses corresponding to the number of the pixels of one horizontal line, a panel image signal corresponding to the number of the pixels of one horizontal line is temporarily stored in the first through fourth source drivers 13a to 13d. In this state, when a latch pulse signal is outputted from the control LSI 30 to the first through fourth source drivers 13a to 13d, a display voltage having a level corresponding to the image signal of each of the pixel sections is outputted from a respective one of the source drivers 13a through 13d to the source voltage lines corresponding to the number of the pixels of one horizontal line.

The control LSI 30 outputs, as a control signal, an enable signal, a start pulse signal and a vertical shift clock signal to each of the gate drivers 14a through 14d. While the enable signal is a low level, the gate voltage line is in the off state. While the enable signal is a high level and the start pulse signal is inputted, the first gate voltage line of the gate driver becomes in an ON state in sync with the rising edge of a vertical shift clock signal. While the enable signal is a high level and the start pulse signal is not inputted, a gate voltage line next to the gate voltage line that previously became in the ON state becomes in the ON state in sync with the rising edge of a vertical shift clock signal.

When one gate voltage line is in the ON state while a display voltage corresponding to the number of the pixels of one horizontal line is outputted to the source voltage line, each of the TFTs 12b which are connected to the gate voltage line and correspond to the number of the pixels of one horizontal line becomes in the ON state. As a result, each of the pixel electrodes 12a of the pixels of the one horizontal line is provided with an electric charge (a display voltage). This causes the state of the display element 11a to be changed, thereby allowing an image to be displayed. Such display control as above is performed repeatedly on each horizontal line, thereby resulting in that an image is displayed on the entire display screen.

Further, in order to perform a pseudo-impulse display for suppressing of moving image blur, the image display device 1 includes an arrangement in which a time-division driving is performed, i.e. an arrangement in which the display panel 10 is driven while one frame is divided into a plurality of subframes. More specifically, according to the time-division driving, display luminance is allocated to each of the subframes so that the time integral value of each subframe's display luminance reproduces the gray-scale characteristic of one frame period which varies depending on an input image signal.

It should be noted that the relationship between frame luminance and the tone level of an input image signal satisfies formula (1) below. According to formula (1), when y (gamma characteristic) is 2.2, it is possible to obtain a characteristic that is close to a characteristic of the actual display.

$$\begin{matrix}( Formula 1 ) & \\ \begin{matrix}( frame luminance ) = {( tone level of input image signal )}^{γ} \\ = ( {( tone level of first subframee )}^{γ} + \\ {( tone level of second subframe )}^{γ} ) / 2\end{matrix} & ( 1 )\end{matrix}$$

Explained below with reference to FIG. 1 is how to arrange the control LSI 30 for the time-division driving. Subsequently explained is a concrete example of allocation of the display luminance to each subframe.

The control LSI 30, as illustrated in FIG. 1, includes a line buffer 31, a timing controller 32, a frame memory data selector 33, a first tone translator 34, a second tone translator 35, an output data selector 36, a first LUT (Look Up Table) 37, and a second LUT 38.

In the line buffer 31, an input image signal is received for every one horizontal line and then temporarily stored. The line buffer 31 includes a receiving port and a sending port separately, and can simultaneously receive and send an input image signal.

The timing controller 32 controls the frame memory data selector 33 such that the timing is alternately switched between the timing of sending data to the frame memory 20 and the timing of reading data from the frame memory 20. The timing controller 32 further controls the data selector 36 so that output timing of the first tone translator 34 and output timing of the second tone translator 35 are alternately selected. In other words, the timing controller 32 controls the output data selector 36 so that the output data selector 36 switches between the first subframe period and the second subframe period. Furthermore, the timing controller 32 outputs, at predetermined timing, a clock signal, a latch pulse signal, an enable signal, a start pulse signal, and a vertical shift clock signal, each generated in accordance with an input synchronization signal.

The frame memory data selector 33 is controlled by the timing controller 32 so that the frame memory data selector 33 alternately selects (i) transmitting an input image signal, which corresponds to one horizontal line, to the frame memory 20 from the line buffer 31 and (ii) reading out an image signal from the frame memory 20, which image signal was stored one frame before and corresponds to one horizontal line. Further, the frame memory data selector 33 transmits the image data read out from the frame memory 20 to the second tone translator 35.

The first tone translator 34 determines the tone level of the first subframe. The first tone translator 34: is provided with the input image signal by the line buffer 31; converts the tone level of the input image signal to a tone level of the first subframe which tone level is used for performing the time-division driving; and outputs the tone level thus converted. A tone level of each of the first subframes is stored in the first LUT 37 so as to correspond to the tone level of an input image signal. When the first tone translator 34 converts the tone level of an input image signal, it refers to the first LUT 37.

The second tone translator 35 determines the tone level of the second subframe. The second tone translator 35: is provided with the input image signal by the frame memory 20 via the frame memory data selector 33; converts the tone level of the input image signal to a tone level of the second subframe which tone level is used for performing the time-division driving; and outputs the tone level thus converted. A tone level of each of the second subframes is stored in the second LUT 38 so as to correspond to the tone level of the input image signal. When the second tone translator 35 converts the tone level of an input image signal, it refers to the second LUT 38. Note that each of the tone levels stored in the first LUT 37 and second LUT 38 is set in accordance with the display luminance to be allocated to each of the subframes, as set forth below.

The output data selector 36 is controlled by the timing controller 32 so that the output data selector 36 switches between the image signal outputted from the first tone translator 34 and the image signal outputted from the second tone translator 35, and outputs either of the image signals as a panel image signal. Specifically, the output data selector 36 outputs, as a panel image signal, the image signal outputted from the first tone translator 34 during the first subframe period whereas it outputs, as a panel image signal, the image signal outputted from the second tone translator 35 during the second subframe period.

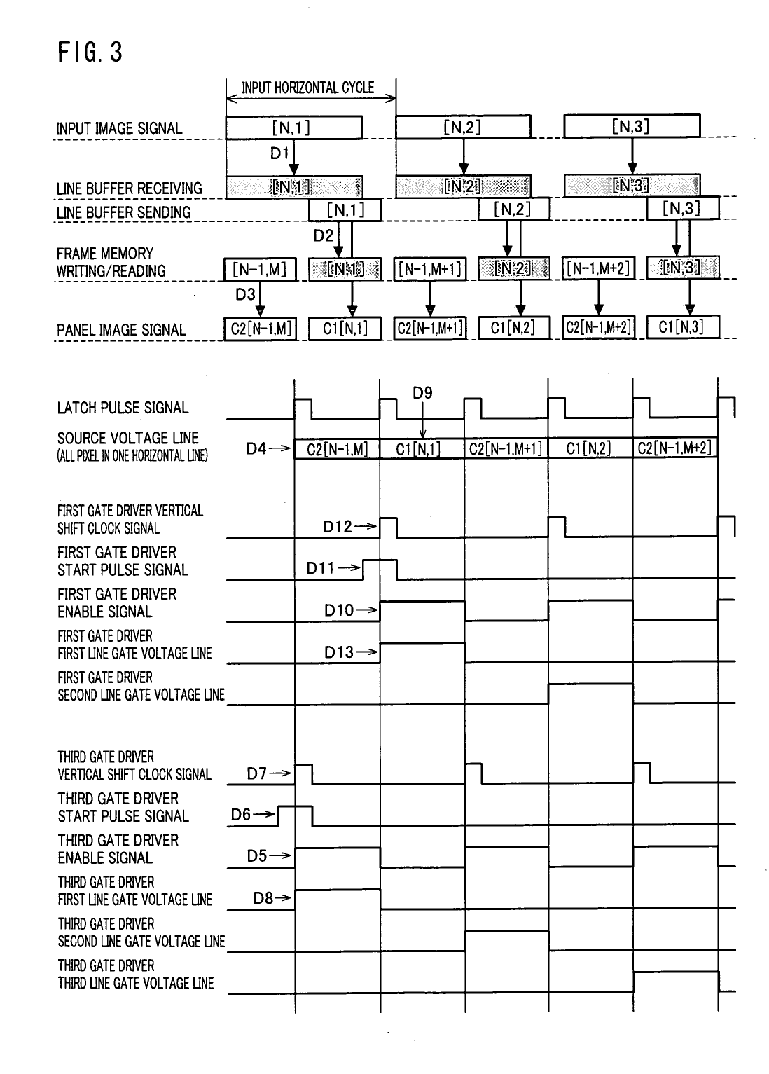

Explained now with reference to FIG. 3 is an operation of the image display device 1 that uses the control LSI 30 having the aforementioned arrangement. FIG. 3 is a diagram illustrating the flow of an image signal for each horizontal period in the image display device of the present embodiment. FIG. 3 deals with a period during which an image input signal for the first through third lines in the Nth frame is inputted.

In FIG. 3, shown in parentheses [ ] is a transmission period of an image signal corresponding to one horizontal line. For example, [N, 1] indicates that the image signal inputted in the first horizontal line in the Nth frame is transmitted. Further, the Mth line indicates the middle line of the screen. According to the present embodiment, the Mth line corresponds to the horizontal line driven by the first gate voltage line of the third gate driver 14c.

Further, C1 indicates the transmitting of the image signal into which the first tone translator 34 has converted an input image signal of the frame and the horizontal line indicated in the following parentheses [ ]. C2 indicates transmitting of the image signal converted into which the second tone translator 35 has converted an input image signal of the frame and the horizontal line indicated in the following parentheses [ ].

First, as the arrow D1 in FIG. 3 shows, an input image signal is received by the line buffer 31. Next, as the arrow D2 shows, in the process where the image signal corresponding to one line is received, (i) the writing of the image signal into the frame memory 20 from the line buffer 31, via the frame memory data selector 33 and (ii) the transmitting of the image signal to the first tone translator 34 from the buffer 31 are collaterally carried out. The converted image signal is outputted from the first tone translator 34 as a panel image signal.

Further, as the arrow D3 shows, (i) an image signal of a horizontal line, which was written one half frame before the image signal to be written into the frame memory 20, is read out from the frame memory 20 for every line. The writing indicated by D2 and the read-out indicated by D3 are alternately carried out. The image signal read out from the frame memory 20 is transmitted to the second tone translator 35 via the frame memory data selector 33. The image signal converted by the second tone translator 35 is outputted as a panel image signal.

The panel image signal corresponding to one horizontal line, outputted from the control LSI 30, is transmitted to the first to fourth source drivers in sync with the clock signal. Then, when a latch pulse signal is supplied to the source drivers, a display voltage is outputted from each of the source voltage lines in accordance with the display luminance of each of the pixel sections. An electric charge (a display voltage) on the source voltage line is provided for a gate voltage line so that an image is displayed with use of the gate voltage line. A vertical shift clock signal and/or a gate start pulse signal are supplied, according to need, to the gate driver that corresponds to a target line to which image display is carried out by supplying a charge (display voltage) via the source voltage line. This causes the scanning signal of a responding gate voltage line to be turned on. In contrast, an enable signal is set to a low level for such a gate driver that does not display an image, and the scanning signal of the gate voltage line is in the off state.

In the example shown in FIG. 3, as the arrow D4 shows, the image signal corresponding to one horizontal line of the Mth line in the N−1 frame is transmitted to the source driver. Subsequently, as the arrow D5 shows, the control LSI 30 supplies an enable signal of high level to the third gate driver 14c. Further, as the arrows D6 and D7 show, a start pulse signal and a vertical shift clock signal are supplied to the third gate driver 14c. As a result, as the arrow D8 shows, such a TFT 12b is turned on that is connected to the first gate voltage line of the third gate driver 14c, thereby displaying an image. The gate voltage line corresponds to the Mth line on the screen. At this stage, an enable signal of low level is supplied to the first, second, and fourth gate drivers 14a, 14b, and 14c, which do not correspond to the display location. The TFTs 12b connected to the gate voltage lines of the foregoing gate drivers are in the off state.

Next, as the arrow D9 shows, the image signal corresponding to one horizontal line of the first line of the Nth frame is transmitted to the source driver. Subsequently, as the arrow D10 shows, the control LSI 30 supplies to an enable signal of high level to the first gate driver 14a. At this stage, as the arrows D11 and D12 show, a start pulse signal and a vertical shift clock signal are supplied to the first gate driver. As a result, as the arrow D13 shows, such a TFT 12b is turned on that is connected to the first gate voltage line of the first gate driver 14a, thereby displaying an image. The first gate voltage line corresponds to the first line on the screen. At this stage, an enable signal of low level is supplied to the second, third, and fourth gate drivers 14b and 14c, which do not correspond to the display location. The TFTs 12b connected to the gate voltage lines of the foregoing gate drivers are in the off state.

In the arrangement, in case of driving each of the pixel sections, one frame period is divided into the first and the second subframe periods. Each of the pixel sections is driven, during the first subframe period, in accordance with an image signal whose level is determined based on a value stored in the first LUT 37. Each of the pixel sections is driven, during the second subframe period, in accordance with an image signal whose level is determined based on a value stored in the second LUT 38.

The values of the first LUT 37 and the second LUT 38 are set so that the time integral value of each subframe's display luminance can reproduce the gray-scale characteristic of one frame period which varies depending on an input image signal. As a result, the sum of the time integral values of the luminance of the pixel section is controlled so that the luminance of one frame period which varies according to the input image signal is reproduced.

Among the values stored in one of the first LUT 37 and the second LUT 38 (for example, the second LUT 38), a value, which is referred to in the case where the input image signal shows that the luminance of a pixel section falls within a predetermined high-luminance region, is set so that the luminance of the pixel section which luminance is determined by referring to such a value is maintained to fall within a predetermined range for a bright display. On the other hand, among the values stored in the other of the first LUT 37 and the second LUT 38 (in this case, the first LUT 37), a value, which is referred to in the case where the luminance of the pixel section falls within the high-luminance region, is set so that the sum of the time integral values of the luminance of the pixel section in one frame period can reproduce the luminance of one frame period which varies according to the input image signal, with use of the luminance of the pixel section, which luminance is determined by referring to such a value.

As a result, when the luminance of the pixel section falls within the high-luminance region, the luminance is kept to fall within the predetermined range for bright display during the second subframe period. The luminance of the first subframe period is controlled so that the luminance of the pixel section in one frame period becomes the luminance represented by the input image signal. According to the present embodiment, the luminance in the predetermined region for bright display is set, for example, to such luminance that provides white.

Among the values stored in one of the first LUT 37 and the second LUT 38 (for example, the first LUT 37), a value, which is referred to in the case where the input image signal shows that the luminance of a pixel section falls within a predetermined low-luminance region, is set so that the luminance of the pixel section which luminance is determined by referring to such a value is maintained to fall within a predetermined range for a dark display. On the other hand, among the values stored in the other of the first LUT 37 and the second LUT 38 (in this case, the second LUT 38), a value, which is referred to in the case where the luminance of the pixel section falls within the low-luminance region, is set so that the sum of the time integral values of the luminance of the pixel section in one frame period can reproduce the luminance of one frame period which varies according to the input image signal, with use of the luminance of the pixel section, which luminance is determined by referring to such a value.

As a result, when the luminance of the pixel section falls within the low-luminance region, the luminance is kept to fall within the predetermined range for dark display during the first subframe period. The luminance of the pixel section in one frame period is controlled so that the luminance of the second subframe period becomes the luminance represented by the input image signal.

According to the present embodiment, the low-luminance region is set, for example, to a luminance region having 10 [cd/m²] or below. The predetermined luminance region for a dark display is set, for example, to such luminance that provides black.

Further, among the values stored in the first LUT 37 and in the second LUT 38, a value, which is referred to in the case where an input image signal shows that the luminance of a pixel section falls within a mid-luminance region having the luminance of 150 [cd/m²] to 350 [cd/m²], is set so that the contrast ratio between the two subframes falls within: a region of not greater than 50 and not smaller than 1.5 when the display luminance is 150 [cd/m²]; a region of not greater than 3.5 and not smaller than 1.5 when the display luminance is 200 [cd/m²]; a region of not greater than 2.2 and not smaller than 1.5 when the display luminance is 250 [cd/m²]; a region of not greater than 1.8 and not smaller than 1.5 when the display luminance is 300 [cd/m²]; and the contrast ratio between the two subframes is 1.5 when the display luminance is 350 [cd/m²]. In display luminance other than each of the above, the contrast ratio is monotonously changed in a region defined by contrast ratios corresponding to the respective display luminance. “The contrast ratio is monotonously changed in a region defined by contrast ratios corresponding to the respective display luminance” means that the contrast ratio is monotonously increased or decreased between any two neighboring contrast ratios which fall within the regions of the constant ratios of each of the display luminance, for example, as shown in FIG. 5 is changed in accordance with a curved line that connects each point.

Among the values stored either in the first LUT 37 and in the second LUT 38, a value, which is referred to in the case where the luminance of the pixel section does not fall within the low-luminance region, the high-luminance region, and the mid-luminance region, is set so that (i) the time integral value of each subframe's display luminance can reproduce the gray-scale characteristic of one frame period which varies depending on the input image signal and (ii) the gray-scale characteristic is smoothly connected to the gray-scale characteristics of neighboring regions out of the low-luminance region, the high-luminance region, and the mid-luminance region.

According to the arrangement, the luminance of each of the subframe periods is set to either bright luminance or luminance close to bright luminance, in a high-luminance region having luminance close to the maximum luminance (i.e. a region having luminance close to white luminance). Therefore, the maximum luminance can be improved as compared to an arrangement in which a dark display period should be provided.

Further, according to the arrangement, the luminance of a pixel section is set to black luminance during at least one (i.e. the first subframe period in this example) of the two subframe periods in a region having low luminance close to the minimum luminance (i.e. the region having luminance close to dark luminance). The luminance of a pixel section is set to bright luminance in at least one (i.e. the second subframe period in this example) of the two subframe periods in the high-luminance region.

For example, a problem in connection with a viewing angle characteristic is posed that there occurs whitish appearance when an MVA liquid crystal panel is viewed at oblique angles. When the luminance of a pixel section is set to either close to black or close to white, whitish appearance is hard to occur. However, whitish appearance strongly occurs when the luminance is set to intermediate luminance between luminance close to black and luminance close to white. Therefore, as in the arrangement, the luminance of each subframe period is set to either dark luminance or bright luminance so that a period can be shortened during which period the luminance of a pixel section is set such that whitish appearance is hard to occur. This allows an improvement in the viewing angle characteristic.

Furthermore, according to the arrangement, it is possible for a difference of luminance to occur between subframes, in a luminance region far from both the maximum luminance and the minimum luminance. While a moving image is displayed, a user's eyes tend to follow an edge of the moving image. In this case, when a hold-type display element is used as a pixel section, it is most likely that an error arises from the user's eyes following the moving image. This causes moving image blur to occur. According to the present arrangement, however, even if a hold-type display element is employed, it is possible to carry out a driving that is similar to an impulse driving, since there is a difference between luminance values of each subframe period. This allows a prevention of moving image blur.

During a time-division driving display, when display luminance is allocated to each subframe so that a high-luminance subframe and a low-luminance subframe are generated, a pseudo-impulse display can be achieved. Therefore, moving image blur can be suppressed. However, the extent to which the effect is achieved depends on the luminance allocation ratio. More specifically, when the allocation ratio is set so that the luminance difference between subframes is large, moving image blur can be suppressed to a large extent. When the allocation ratio is set so that the luminance difference between subframes is small, moving image blur can be suppressed to a small extent.

Note however that, In the case of displaying a bright image and a dark image, both having a similar blur width, visibility of the bright image is better than that of the dark image. Therefore, the brighter the image to be displayed, the less needed the impulse effect.

On the other hand, when a time-division driving is performed, a problem arises that a flicker occurs more often, although moving image blur can be reduced. Further, the likelihood of a flicker is high when an allocation ratio is employed in which the luminance difference between subframes is large. In contrast, the likelihood of a flicker is low when an allocation ratio is employed in which the luminance difference between subframes is small.

Assume a period A during which a luminance value X is shown and a period B during which a luminance value O is shown. It is known that a certain frequency determines whether the luminance values of the two periods are recognized as equal to or different from each other. Such a certain frequency is referred to as CFF (critical fusion frequency) for example and, in general, is said to increase in proportion to the logarithm of luminance. Additionally, when the luminance values of the two periods are recognized as equal, the luminance is defined by the formula X·A/(A+B), where the two period have lengths of A and B, respectively.

According to a report related to medical physiology, the frequency is in the range of 10 Hz to 20 Hz under the condition of normal brightness, and will reach approximately 50 Hz in a brighter environment.

However, the report is often based on an experiment that was conducted under conditions that a particular kind of lamp was viewed in a dark room. Therefore, the situation is largely different from the conditions below, i.e., under conditions that a screen that is large to some extent is viewed in a large room, like an image display device.

In more detail, the research described in the report was mostly conducted on a dark region having luminance of up to 150 [cd/m²]. In contrast, luminance of an image display device sometimes falls in the range of 400 to 600 [cd/m²].

In addition, a lamp was viewed according to the report. However, on the screen of an image display device, bright portions and dark portions are mixed. In this case, different adjustments are made in visual sensation, depending on the timing of looking at each portion and on the point of the user's focus. This causes different changes in sensitivity. As a result, such a setting is required that can deal with the case where a user's eyes are more adapted to view flicker.

Further, most medical experiments are carried out on the assumption that a user looks at an object basically at the center of the visual field, as in looking at a lamp. This causes the stimulus to be recognized as a cone shape. On the other hand, in the case of viewing an image display device, as the image display device becomes larger, the part of a user's visual field the user activates to look at each portion of a screen differs depending on which portion of the screen the user views. In this case, it is more easily to recognize a flicker since recognition by rod photoreceptor cells and recognition by cone photoreceptor cells are mixed.

High-definition technology of an image display device has been advancing, represented by such an image display device that can deal with high-definition broadcasting. If noise is not caused, a more beautiful image can be displayed. As a result of an original image becoming more beautiful, smaller noise easily becomes visible as noise, and consequently, such an image display device is more susceptible to noise.

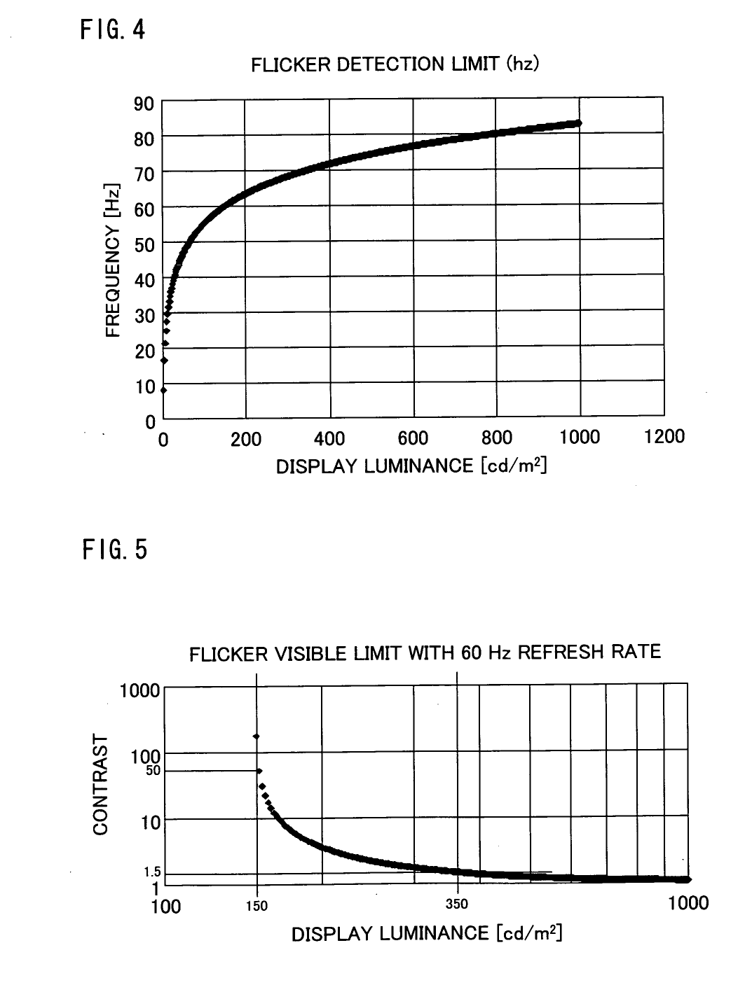

In view of such conditions, the inventors subjectively assessed the critical fusion frequency in an image display device. The result is shown in FIG. 4. As illustrated in FIG. 4, the flicker visible limit has already reached 60 [Hz] at 200 [cd/m²]. Therefore, a flicker having a frequency of 60 [Hz] or so can be tolerated if the maximum luminance is approximately 250 [cd/m²] as in a CRT display device. However, image interference by a flicker decreases display quality to an intolerably large degree in an image display device, such as a liquid crystal display device, in which the maximum luminance reaches 500 to 600 [cd/m²].

Further, a flicker is a repeated luminance change between bright luminance and dark luminance, and therefore is more visible to a user. Also, it is generally known that luminance determination is exponentially compressed. However, this is concerned with determination of stable luminance, and a luminance change, such as a flicker, that occurs so rapidly that a user's eyes cannot make adjustments, tends to be more visible.

The inventors conducted experiments to subjectively assess the display luminance of one frame (display luminance) and the flicker-detection limit contrast, with regard to an image display device in which a frame frequency of 60 Hz, i.e. a refresh rate of 60 [Hz] is used, as in an NTSC image display device. The result obtained is illustrated in FIG. 5.

Further, the inventors had the subject assess whether or not a flicker was perceptible in an image display device in which a refresh rate of 60 [Hz] is used. In the experiment, the luminance value in one of the subframe periods was changed, with respect to each combination of the display luminance value of one frame and the contrast ratio value. As a result, it was revealed that whether or not a flicker is perceptible is determined in accordance with the combination of the display luminance value of one frame and the contrast ratio value, irrespective of the luminance for each subframe period. In other words, it was revealed that the display luminance that causes a flicker is defined by a certain contrast ratio, irrespective of the luminance for each subframe period.

As illustrated in FIG. 5, according to the assessment of the subject, (i) a flicker was not perceptible when the luminance is not greater than 150 [cd/m²] no matter what value the contrast ratio is set to and (ii) when the luminance is greater than 150 [cd/m²], a flicker is perceptible depending on the display luminance.

Further, according to the assessment of the subject, in an image display device in which a refresh rate of 60 [Hz] is used, a flicker is not perceptible, provided that the contrast ratio is: not greater than 50 when the display luminance is 150 [cd/m²]; not greater than 3.5 when the display luminance is 200 [cd/m²]; not greater than 2.2 when the display luminance is 250 [cd/m²]; not greater than 1.8 when the display luminance is 300 [cd/m²]; not greater than 1.5 when the display luminance is 350 [cd/m²]; or, when the display luminance is different from each of the above, simply set so as to monotonously change between the contrast ratios of the above display luminance values. According to the assessment of the subject, when the contrast ratio for each display luminance value is more than the above, a flicker is perceptible.

The inventors conducted experiments for a subject to subjectively assess whether or not moving image blur would occur in an image display device in which a refresh rate of 60 [Hz] is used. In the experiments, the contrast ratio between two subframes was changed. The experimental results revealed that moving image blur can be reduced significantly when the contrast ratio is 3.0 or greater, and that moving image blur can be suppressed when the contrast ratio is 1.5 or greater.

The experimental results revealed that, in an image display device in which a refresh rate of 60 [Hz] is used, moving image blur can be suppressed while preventing flicker from being visible, provided that the contrast ratio is: not greater than 50 and not smaller than 1.5 when the display luminance is 150 [cd/m²]; not greater than 3.5 and not smaller than 1.5 when the display luminance is 200 [cd/m²]; not greater than 2.2 and not smaller than 1.5 when the display luminance is 250 [cd/m²]; not greater than 1.8 and not smaller than 1.5 when the display luminance is 300 [cd/m²]; 1.5 when the display luminance is 350 [cd/m²]; or, when the display luminance is different from the above, simply set so as to monotonously change between the contrast ratios that correspond to each of the above display luminance values. The experimental results also revealed that no effect of suppressing the moving image blur was obtainable when the contrast ratio was set so that a flicker is not perceptible in a region where a display luminance value was more than 350 [cd/m²].

In an image display device in which white luminance is 500 [cd/m²], when the setting of each of the aforementioned contrast ratios is expressed in terms of luminance differences, the upper limit value which the subject recognizes are as follows: a luminance difference between subframes is: 300 [cd/m²] or less when the display luminance is 150 [cd/m²]; 230 [cd/m²] or less when the display luminance is 200 [cd/m²]; 190 [cd/m²] or less when the display luminance is 250 [cd/m²]; 160 [cd/m²] or less when the display luminance is 300 [cd/m²]; and 150 [cd/m²] when the display luminance is 350 [cd/m²]. According to the assessment of the subject, (i) when the display luminance was different from the above, no flicker was perceptible provided that the luminance value was set so as to monotonously change between the luminance differences of the above display luminance values and (ii) a flicker was perceptible when the luminance difference between subframes of the above display luminance value was more than the above luminance difference. “The luminance difference is monotonously changed in a region defined by contrast ratios corresponding to the respective display luminance” means that the luminance difference is monotonously increased or decreased between any two neighboring contrast ratios which fall within the regions of the constant ratios of each of the display luminance, for example, as shown in FIG. 5 is changed in accordance with a curved line that connects each point.

The inventors conducted experiments, similar to each of the aforementioned experiments conducted with regard to an image display device in which a refresh rate of 60 [Hz] is used, with regard to an image display device in which a refresh rate of 50 to 70 [Hz] is used. As a result, the inventors confirmed that no difference could be found which supported that an image display device in which a refresh rate should preferably be designed differently from an image display device in which a refresh rate of 60 [Hz] was used. More specifically, even in an image display device in which a refresh rate of 50 to 70 [Hz] was used, the following has been confirmed: flicker-visible display luminance is defined by a certain contrast ratio, irrespective of luminance in each subframe period; provided that the luminance is not greater than 150 [cd/m²], a flicker is not visible no matter what value the contrast ratio is set to, whereas in the case where the luminance is over 150 [cd/m²], a flicker is visible, depending on the display luminance; in a region which has a display luminance value of over 350 [cd/m²], in the case where the setting is made so that a flicker is not visible, moving image blur cannot be suppressed at all; and a flicker is not visible if the contrast ratio is set in the same numerical range as in an image display device that has a refresh rate of 60 [Hz], and a flicker is visible in the case where the contrast ratio for each display luminance value is more than the above. Note that, when the refresh rate is less than 50 [Hz] as in a cinema film (24 Hz), it is not effective to put in low-luminance display fields so that moving-picture performance is improved since the visibility of a flicker is too good. Further, if the refresh rate is excessively high, the display practically will become flicker-less.

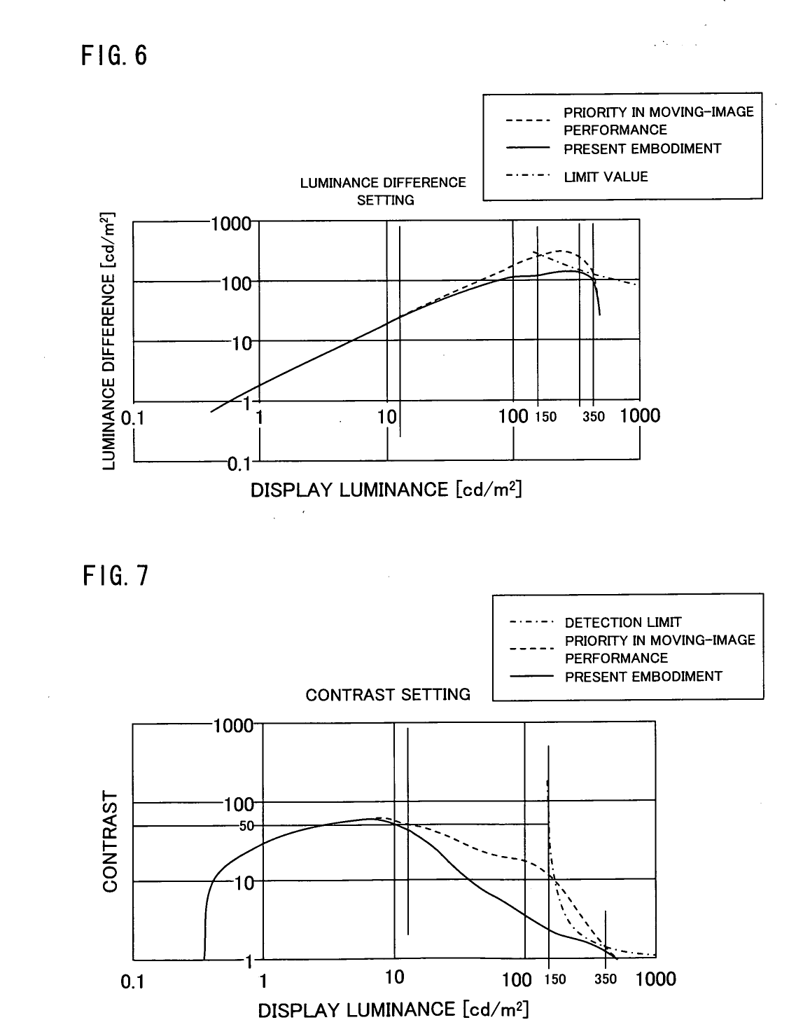

According to an image display device in which bright luminance is 500 [cd/m²], when luminance is allocated so that the luminance difference is as large as possible without considering a flicker, a characteristic of display luminance and luminance difference is obtained as illustrated by a dotted line in FIG. 6. In this case, as illustrated in FIG. 6, the luminance difference grows larger as the display luminance increases. However, when the display luminance of the frame period is not become the specified luminance even after the luminance of the second subframe is set to bright luminance, a control is carried out by increasing the luminance of the first subframe so that the display luminance of the frame period becomes the specified display luminance. Therefore, when the display luminance value exceeds a certain level, the luminance difference gradually decreases. In FIG. 6, a dashed line shows a graph illustrating the luminance difference (i.e. the limit value of luminance difference) converted from the flicker-detection limit contrast illustrated in FIG. 5.

FIG. 6 shows a relationship between the luminance of each subframe and the display luminance which are obtained as a result of luminance allocation performed by the image display device 1 of the present embodiment. The relationship is shown by a graph defined by the luminance difference between subframes and the display luminance. This relationship can be shown by a graph defined by the contrast ratio between subframes and the display luminance as in FIG. 7. The flicker-detection limit contrast is shown by the dashed line. Further, a characteristic of display luminance and contrast ratio is shown by the dotted line in FIG. 7 as well as in FIG. 6, in which characteristic luminance is allocated so that the luminance difference is as large as possible.

As described above, according to an image display device in which a refresh rate is 60 [Hz], it is important that the contrast ratio or the luminance difference between each subframe be set in the above numerical range in the mid-luminance region of 150 to 350 [cd/m²] so that flicker is prevented from being visible and moving image blur is suppressed. According to the image display device 1 of the present embodiment, as illustrated by a solid line in FIGS. 6 and 7, the contrast ratio and the luminance difference in the mid-luminance region are set in the range described above. As a result, flicker can be prevented from being visible and moving image blur can be suppressed as contrasted to the arrangement illustrated by a dotted line in FIGS. 6 and 7, i.e. an arrangement in which the luminance is distributed so that the luminance difference is as large as possible.

As illustrated in FIG. 6, the dotted line indicative of the characteristic of display luminance and luminance difference and the dashed line indicative of the limit value, intersect at the point of 350 [cd/m²]. As such, even if the luminance is allocated so that the luminance difference is as large as possible with regard to an image display device in which bright luminance of 500 [cd/m²] is used and in which the following driving method is employed, no flicker becomes perceptible in a region having luminance of more than 350 [cd/m²]. The driving method is directed to a method in which, in the high-luminance region, (i) the luminance of the second subframe is kept in the luminance range for a bright display and (ii) the luminance of the first subframe is increased so that the display luminance of the frame period becomes the specified display luminance.

Further, according to the image display device 1 of the present embodiment, (i) the luminance allocation for each subframe in the mid-luminance region is set as above and (ii) the luminance difference and the contrast ratio are set so that the luminance difference of each subframe in the mid-luminance region is kept substantially at a constant level. As a result, even if there exist in the display element array 11 a plurality of pixel sections whose luminance is set to a luminance falling within the mid-luminance region, it is possible to suppress the occurrence of the problem that display quality is decreased because a luminance difference between subframe periods largely differs from pixel section to pixel section. As a result, it is possible to stably display an image having complex luminance distribution, thereby realizing to display a moving image with high quality.

Explained now is an effect of keeping the luminance difference substantially at a constant level in the mid-luminance region. According to an original flicker-visibility test, a dark screen and a bright screen are alternately presented. It is known that, in this case, luminance determination is exponentially compressed. However, according to the above test, (i) a change in sensitivity caused by “adaptation” is taken into consideration beforehand (ii) there is provided, in addition to optic nerve, a mechanism in which sensitivity is more increased in a region having low accumulated luminance (display luminance) and (iii) visual sensitivity is more decreased in a region having high accumulated luminance. Therefore, the visual perception cannot afford to be adapted when an image is viewed in a situation, different from that in the test, such as a situation of normal television broadcast, i.e., a situation of displaying an image having a lot of luminance values (tones) which are mixed; a situation of viewing luminance which varies between a central visual field and a peripheral visual field because of increase in a screen size; or a situation in which an image to which an attention is paid moves (a moving image). This causes a provision of characteristic different from that in the test. Consequently, an image is often viewed under a situation different from that in the test. For example, in the case where the contrast in the mid-luminance region is set to a constant level, when the eyes which has adapted to a dark image view the mid-luminance region, the enlarged luminance difference (the display luminance multiplied by the contrast) is misjudged as an enlarged contrast, instead of enlarged luminance. This is likely to cause a flicker to be recognized. It is likely that the enlarged luminance difference is recognized as roughness or noise in repeated movement of viewing field, even if a flicker is not recognized. Consequently, the contrast is preferably within the aforementioned limit, and it is preferable that the luminance difference is further kept at a constant level within the foregoing contrast limit as in the present embodiment, especially when television broadcast is displayed.

More specifically, it is preferable that the luminance difference between the first and second subframe periods falls within the range of 100 to 200 [cd/m²], in the range having accumulated luminance of 100 to 350 [cd/m²]. As a result, in a low-luminance region (in a region having accumulated luminance of 100 to 350 [cd/m²]), it is become difficult that the enlarged luminance difference is perceived because of the adaptation, and therefore, the influence of the luminance difference becomes smaller. On the other hand, in a region having high luminance (i.e. in the region having accumulated luminance of more than 350 [cd/m²]), the luminance difference is not to be paid attention to for the purpose of achieving desired accumulated luminance. In addition, when the luminance difference is less than 100 [cd/m²], a moving image cannot be fully improved in many regions. When the luminance difference is more than 200 [cd/m²], a flicker or noise is perceived in many regions.

Further, as illustrated by a solid line in FIGS. 6 and 7, the image display device 1 of the present embodiment performs control in which the contrast ratio is secured as much as possible. In a low-luminance region that has extremely low luminance of 10 [cd/m²] or less, the luminance of a pixel section is maintained in a range for a dark display during the first subframe period. The display luminance of one frame period is defined by the luminance of the second subframe period. As a result, the contrast ratio can be secured sufficiently, and moving image blur can be suppressed effectively. In addition, in the luminance region, the contrast ratio and the luminance difference increase substantially in a simple manner with respect to the display luminance of one frame period.

Still further, as illustrated by a solid line in FIGS. 6 and 7, the image display device 1 of the present embodiment performs control in which, in a high-luminance region that has extremely high luminance, the luminance of a pixel section is maintained in a range for a bright display during the second subframe period. The display luminance of one frame period is defined by the luminance of the first subframe period.

As a result, in the high-luminance region, the luminance of each subframe period is set to bright luminance or luminance close to bright luminance. Therefore, the maximum value of the display luminance of one frame period can be improved compared to an arrangement in which a dark display period is always provided.

Yet further, according to the image display device 1 of the present embodiment, in a region that does not correspond to the low-luminance region, the high-luminance region, or the mid-luminance region, the luminance is allocated in a manner described below. The time integral value of the display luminance of each subframe can reproduce the gray-scale characteristic of one frame period which varies depending on an input image signal. Furthermore, the gray-scale characteristic can be connected smoothly to the characteristics of neighboring two of the low-luminance region, the high-luminance region, and the mid-luminance region. An inflection point can be provided in a characteristic of display luminance and luminance difference or a characteristic of display luminance and contrast ratio, on the interface between luminance regions so that the characteristic is changed drastically on the interface between luminance regions. In this case, there may occur a defect such as an irregularity caused by moving image blur. According to the image display device 1 of the present embodiment, since the luminance is allocated so that the characteristic is connected smoothly, the above defect can be prevented. As described above, in a region which does not correspond to the low-luminance region, the high-luminance region, or the mid-luminance region, the luminance of each subframe is defined more often by easiness of setting a source driver voltage and smoothness of the display tone luminance than by the display quality.

As described above, in relation to the display characteristic and the viewing angle characteristic, there exist in an image display device: a region in which improvement in the moving-image performance should be pursued without considering a flicker (i.e. the low-luminance region); another region in which efforts should be made so that the display luminance is secured without considering the moving-image performance (i.e. the high-luminance region); another region that flicker visibility and improvement in the moving-image performance should be balanced (i.e. the mid-luminance region); and other regions that connect each of the above parts.

According to the image display device of the present embodiment, the luminance region that the image display device can provide is divided according to each of the above regions at a time of determining the way luminance is allocated, i.e. at a time of determining values of the first LUT 37 and second LUT 38. Priority is given to suppressing a flicker in the mid-luminance region in which there is a tradeoff between a flicker and moving-image performance. In other regions, the performance that each region is to emphasize should be exhibited to the utmost extent, while making possible smooth transition to other regions.

Explained above is an arrangement in which luminance is allocated to each subframe with reference to the LUT. However, the present invention is not limited to this. For example, circuits described below may be provided. One circuit determines which of the above luminance regions corresponds to the luminance of a pixel section corresponding to an input image signal. Further, another circuit, when the above circuit determines that the luminance is in the mid-luminance region, allocates the luminance to each subframe so that the contrast ratio or the luminance difference is set substantially at a constant level. According to the arrangement, since the contrast ratio or the luminance difference is set substantially at a constant level in the mid-luminance region, even when allocation is performed with the use of the circuits in place of LUTs, the circuit scale is not become larger.

In addition, according to the present embodiment, as described above, the control described below is performed. When an input image signal shows that the luminance of a pixel section falls within the high-luminance region, the sum of the time integral values of the luminance of a pixel section of one frame period can reproduce the luminance of one frame period which varies according to the input image signal. This can be achieved by maintaining the luminance of at least one of the plurality of subframe periods in a predetermined range for a bright display so that the luminance of the other subframe period is controlled. Further, the control described below is also performed. When an input image signal shows that the luminance of a pixel section falls within the low-luminance region, the sum of the time integral values of the luminance of a pixel section can reproduce the luminance of one frame period which varies according to the input image signal. This can be achieved by maintaining the luminance of at least one of the plurality of subframe periods in a predetermined range for a dark display so that the luminance of the other subframe period is controlled. However, the present invention is not limited to this. When the contrast ratio or the luminance difference is set as described above in the mid-luminance region of 150 [cd/m²] to 350 [cd/m²], a similar effect can be obtained.

However, as described above, when the luminance of each subframe period is set to bright luminance or luminance close to bright luminance in the high-luminance region, the maximum luminance can be improved compared to an arrangement which always employs a dark display period.

On the other hand, in the low-luminance region, by maintaining the luminance of at least one subframe period in a predetermined range for a black display, the contrast ratio in the region can be set large. As a result, moving image blur can be reduced.

Further, the operation explained above with reference to FIG. 3 is merely an example of performing the time-division driving in the image display device 1. The present invention is not limited to this.

For example, explained in the aforementioned description is the case in which the number of divided subframes is 2, and the divisional ratio of the subframes is 1 to 1. However, the number into which a frame is divided is not limited to this, and one frame may be divided into 3 or more subframes. Furthermore, the divisional ratio does not need to be equally 1 to 1, and the frame can be divided into two subframes based on any divisional ratio (for example, 2 to 1 or 3 to 2). In this case, when the number of subframes is set to n, the maximum value of the luminance in each subframe period in the step of time-division driving may be set to the frame average luminance multiplied by n.

Still further, according to the inventor's study, the critical point (i.e. the flicker visible limit) which is fundamental to the present invention does not depend on the number of divided subfields. For example, in the case of a display device in which the refresh rate of 60 Hz is used, the relationship between the display luminance and the flicker visible contrast can be discussed in exactly the same manner with respect to the divisional numbers of 2 (dark and bright), of 3 (dark, dark and bright) (dark, bright and bright) or of 4 (dark, dark, dark and bright) (dark, bright, bright and bright) (dark, dark, bright and bright). It is preferable that the display luminance to be controlled (150 to 350 [cd/m²]) and the contrast ratio for the luminance are similarly controlled. Further, in the case where there are 2 or more kinds of dark luminance or bright luminance, the first and second subframe periods have the minimum value and the maximum value in the field. Note that when the divisional number is 4 or more, e.g. the four are (dark 1, dark 2, bright 1 and bright 2), and when the two kinds of bright and two kinds of dark are each at a similar level, the actual refresh frequency doubles. However, in the case of the divisional number of 4 or more, when bright 1 is relatively dark, or when dark 2 is relatively bright, i.e. when the luminance variation frequency is equal to the refresh frequency, the contrast ratio can be limited (the luminance division can be controlled) in the same manner as in the present embodiment with respect to the minimum and maximum luminance in the period.

The present invention can be implemented in many other ways within the range of the primary characteristics described above. Therefore, the embodiment described above is merely an example in various respects, and the present invention should not be narrowly interpreted. The scope of the present invention is illustrated in the claims, and therefore is not bound by the specification. In addition, any transformations or modifications within the scope equivalent to the scope of the claims are all within the range of the present invention.

### INDUSTRIAL APPLICABILITY

The present invention is widely applicable to an image display device, such as a liquid crystal television receiver or a liquid crystal monitor, which uses a hold-type display element.

1. A method for displaying an image by dividing one frame period into a plurality of subframe periods,
a frequency in said one frame period falling in a range of 50 to 70 Hz, said method comprising the step of:
performing a time-division driving in which, in a range of 150 [cd/m²] to 350 [cd/m²] of frame average luminance of a pixel which range is specified by an input signal, (i) luminance of a first subframe period which is at least one of the subframe periods is set so as to be greater than the frame average luminance, and (ii) luminance of a second subframe period which is at least other one of the subframe periods is set so as to be smaller than the frame average luminance,
a contrast ratio between the first and second subframe periods in the time-division driving being set to: a range of not greater than 50 and not smaller than 1.5 when the frame average luminance is 150 [cd/m²]; a range of not greater than 3.5 and not smaller than 1.5 when the frame average luminance is 200 [cd/m²]; a range of not greater than 2.2 and not smaller than 1.5 when the frame average luminance is 250 [cd/m²]; a range of not greater than 1.8 and not smaller than 1.5 when the frame average luminance is 300 [cd/m²]; 1.5 when the frame average luminance is 350 [cd/m²], and
for a frame average luminance other than said frame average luminance in said range, a contrast ratio being set so as to be monotonously changed between the contrast ratios corresponding to said respective frame average luminance.

2. A method for displaying an image by dividing one frame period into a plurality of subframe periods,
a frequency in said one frame period falling in a range of 50 to 70 Hz, said method comprising the step of:
performing a time-division driving in which, in a range of 150 [cd/m²] to 350 [cd/m²] of frame average luminance of a pixel which range is specified by an input signal, (i) luminance of a first subframe period which is at least one of the subframe periods is set so as to be greater than the frame average luminance, and (ii) luminance of a second subframe period which is at least other one of the subframe periods is set so as to be smaller than the frame average luminance,
a contrast ratio between the first and second subframe periods in the time-division driving being set to not smaller than 1.5,
a luminance difference between the first and second subframe periods in the time-division driving being set to: a range of not greater than 300 [cd/m²] when the frame average luminance is 150 [cd/m²]; a range of not greater than 230 [cd/m²] when the frame average luminance is 200 [cd/m²]; a range of not greater than 190 [cd/m²] when the frame average luminance is 250 [cd/m²]; a range of not greater than 160 [cd/m²] when the frame average luminance is 300 [cd/m²]; 150 [cd/m²] when the frame average luminance is 350 [cd/m²], and
for a frame average luminance other than said frame average luminance in said range, a luminance difference being set so as to be monotonously changed between the contrast ratios corresponding to said respective frame average luminance.

3. The method of displaying an image according to claim 1, wherein a luminance difference between the first and second subframe periods in the time-division driving falls within a range of 100 to 200 [cd/m²], at least in a range of 100 to 350 [cd/m²] of the accumulated luminance.

4. The method of displaying an image according to claim 2, wherein a maximum value of luminance in each of the subframe periods in the time-division driving is indicated by a product of frame average luminance and n where n indicates the number of the subframes.

5. An image display device including driving means for dividing one frame period into a plurality of subframe periods so that an image is displayed,
a frequency in said one frame period falling within a range of 50 to 70 Hz;
the driving means controlling the plurality of subframe periods so that, in a range of 150 [cd/m] to 350 [cd/m²] of frame average luminance of a pixel which range is specified by the input signal, (i) luminance of a first subframe period which is at least one of the subframe periods is greater than the frame average luminance, and (ii) luminance of a second subframe period which is at least other one of the subframe periods is smaller than the frame average luminance,
the driving means setting a contrast ratio between the first and second subframe periods to: a range of not greater than 50 and not smaller than 1.5 when the frame average luminance is 150 [cd/m²]; a range of not greater than 3.5 and not smaller than 1.5 when the frame average luminance is 200 [cd/m²]; a range of not greater than 2.2 and not smaller than 1.5 when the frame average luminance is 250 [cd/m²]; a range of not greater than 1.8 and not smaller than 1.5 when the frame average luminance is 300 [cd/m²]; 1.5 when the frame average luminance is 350 [cd/m²], and
for a frame average luminance other than said frame average luminance in said range, the driving means setting a contrast ratio so as to be monotonously changed between the contrast ratios corresponding to said respective frame average luminance.

6. An image display device including driving means for dividing one frame period into a plurality of subframe periods so that an image is displayed,
a frequency in said one frame period falling within a range of 50 to 70 Hz;
the driving means controlling the plurality of subframe periods so that, in a range of 150 [cd/m²] to 350 [cd/m²] of frame average luminance of a pixel which range is specified by the input signal, (i) luminance of a first subframe period which is at least one of the subframe periods is greater than the frame average luminance, and (ii) luminance of a second subframe period which is at least other one of the subframe periods is smaller than the frame average luminance,
the driving means sets a contrast ratio between the first and second subframe periods in the time-division driving to not smaller than 1.5; and
a luminance difference between the first and second subframe periods in said range set to: a range not greater than 300 [cd/m²] when the frame average luminance is 150 [cd/m²]; a range of not greater than 230 [cd/m²] when the frame average luminance is 200 [cd/m²]; a range of not greater than 190 [cd/m²] when the frame average luminance is 250 [cd/m²]; a range of not greater than 160 [cd/m²] when the frame average luminance is 300 [cd/m²]; 150 [cd/m²] when the frame average luminance is 350 [cd/m²], and
for a frame average luminance other than said frame average luminance in said range, the driving means setting a luminance difference so as to be monotonously changed between the contrast ratios corresponding to said respective frame average luminance.

7. The image display device according to claim 5, wherein the driving means sets a luminance difference between the first and second subframe periods to a range of 100 to 200 [cd/m²], at least in a range of 100 to 350 [cd/m²] of the accumulated luminance.

8. The image display device according to claim 6, wherein the driving means determines a maximum value of luminance in each of the subframe periods as indicated by a product of frame average luminance and n where n indicates the number of the subframes.

9. An image display monitor comprising:
an image display device recited in claim 5; and
a signal input section which transmits an externally input image signal to the image display device.

10. A television receiver comprising:
a receiving apparatus which receives television broadcast; and
an image display device recited in claim 5,
the image display device displaying an image of the television broadcast received by the receiving apparatus.

11. An image display monitor comprising:
an image display device recited in claim 6; and
a signal input section which transmits an externally input image signal to the image display device.

12. A television receiver comprising:
a receiving apparatus which receives television broadcast; and
an image display device recited in claim 6,
the image display device displaying an image of the television broadcast received by the receiving apparatus.
